(19) United States
(12) Patent Application Publication
(10) Pub. No.: US 2023/0326688 A1
(43) Pub. Date: Oct. 12, 2023

(54) ELECTRICAL SYSTEM

(71) Applicant: IIE GMBH & CO. KG, SOYEN (DE)

(72) Inventor: EKKEHARD KRESS, WASSERBURG (DE)

(21) Appl. No.: 16/766,820

(22) PCT Filed: Nov. 26, 2018
(86) PCT No.: PCT/EP2018/082532

§ 371 Date: Jun. 5, 2023

(30) Foreign Application Priority Data
Nov. 29, 2017 (DE) 10 2017 011 040.9

(51) Int. Cl. H01H 3/24; H01H 83/10

(52) U.S. Cl. CPC H01H 3/24; H01H 83/10; H01H 2231/026

(57) ABSTRACT

An electrical system is provided. In a non-limiting embodiment, an electrical system may include a load circuit comprising a plurality of series-connected storage/converter cells for supplying the load circuit, and an event sensor. Isolator switches may be provided between series-connected storage/converter cells, said isolator switches being in a closed position during normal operation of the electrical system, and being arranged such that they change to an open position when the event sensor is triggered.

The invention relates to an electrical system according to the preamble of claim 1.

Pollutant emissions from internal combustion engines have been taken increasingly seriously in recent years. The use of electric motors is strongly encouraged in the mobile sector in order to reduce these emissions. It is assumed that the demand for electrical power can be met to an increasing extent through renewable energies.

In most cases, large currents and high voltages are necessary to replace internal combustion engines with electric motors. A large number of electrical storage cells, currently mostly lithium-ion batteries, are therefore series-connected.

The individual cells usually work with a voltage of approximately 3.6 V. In particular when used in motor vehicles, a voltage of more than 300 V is required for the electric motors, so that more than one hundred such cells have to be connected accordingly. Voltages of approximately 700 V are already being used today in certain vehicles.

The live parts in this case are well insulated so that no voltage can be transmitted to users in normal operation. In contrast to a stationary system, however, an incident can quickly occur in the mobile sector, resulting in considerable mechanical deformations. Thus, for example, in the event of a collision, it cannot be ruled out that electrical insulation is damaged and high voltages are transmitted to parts with which the user can come into contact. This can lead to serious injury or even death of the accident victim.

In the case of stationary electrical systems, such high voltages occur, for example, in houses on the roofs of which photovoltaic systems are installed. If there is a fire, the firefighters extinguishing the fire are exposed to a great danger, since, with the high voltages that occur, the possibility of a flashover via the fire-fighting water onto the people cannot be ruled out.

The invention has for its object to design an electrical system according to the preamble of claim 1 so that such dangers can be safely avoided after an unforeseen event.

The object is achieved according to the invention by an electrical system having the features of claim 1. Because closed isolator switches are provided between series-connected storage/converter cells during normal operation of the electrical system and are designed and/or arranged such that they are opened when the event sensor is triggered, the high voltage can be divided into smaller, harmless voltages if there is an unforeseen event.

For example, after an accident, voltage may thus be present on parts of an electrically driven transportation means with which the accident victim or potential rescuer come into contact, but these voltages are so low that they cannot lead to any damage. Of course, the risk of fire after an accident is also enormously reduced by the invention, since the likelihood of short circuits in the wiring between the storage cells becomes much less due to the separation of the electrical circuit into segments that are insulated from one another. When the invention is used in an electrically driven transportation means, the event sensor is advantageously designed as an impact sensor.

If a house has a fire and a photovoltaic system is installed on its roof, the isolator switches between photovoltaic elements, which are so-called transducer cells, are triggered, for example, by a smoke detector or another fire detector. Here, too, the high voltage is divided into smaller, safe voltages so that there is no danger to the firefighters when extinguishing the fire.

The invention can be used, among other things, in all electrically driven transportation means. All devices for the transportation of people and/or goods by land, water and air are to be considered here as transportation means. “Electrically driven” means all transportation means that are at least partially electrically driven. This also includes so-called hybrid vehicles, which are driven partly by an electric motor and partly by an internal combustion engine. The load circuit here includes the drive in particular. In the case of a photovoltaic system, on the other hand, the load circuit has an inverter and possibly an energy store.

All voltage-storing and all voltage-generating cells are to be considered as storage/converter cells. For example, rechargeable lithium-ion cells, or pure charge storage such as capacitors are used as storage cells. The transducer cells include fuel cells and photovoltaic cells.

A sensor provided specifically for actuating the isolator switch can be used as an event sensor. In particular, however, the signal from an event sensor is used, which is present anyway. The impact sensor of an existing airbag can be mentioned here as an example of a transportation means and an already installed smoke detector can be mentioned as an example of a house having a photovoltaic system. The costs for the electrical system according to the invention can be reduced in this way.

Further details and advantages of the invention emerge from the dependent claims.

In order to be able to achieve the advantages mentioned, an isolator switch does not necessarily have to be provided between all storage/converter cells. Depending on the output voltage of each individual storage/converter cell, it is sufficient for most known storage/converter cells that the isolator switches are located between groups of storage/converter cells which are combined such that each group delivers a voltage which is not harmful to people. The output voltage of such a group of storage/converter cells should therefore not exceed 50 V if possible.

At least one additional isolator switch is advantageously provided between the series-connected storage/converter cells and the load circuit, the additional isolator switch being in a closed position during normal operation of the electrical system. In this way, the load circuit can be disconnected from the storage/converter cells if there is an unforeseen event. If two additional isolator switches are used, a complete disconnect between the load circuit and the storage/converter cells can even be achieved. For example, when using the electrical system according to the invention in a house having a photovoltaic system, the inverter of the load circuit can be completely disconnected from the photovoltaic system in this way.

The at least one additional isolator switch is particularly advantageously combined with a main switch which, after the event sensor has been triggered, is in a position in which the load circuit is short-circuited to the ground of an electrically driven transportation means. The combined disconnect/main switch can thus function as an on/off switch during normal operation of an electrically driven transportation means and as a changeover switch in the event of an accident. In this way, the storage/converter cells can be disconnected from the load circuit when the transportation means is at rest.

A combined disconnect/main switch can also be provided both between the negative pole and between the positive pole of the series-connected storage/converter cells and the load circuit, so that the load circuit is completely disconnected from the storage/converter cells in the rest position. After an accident, the load circuit is connected to ground on both sides. This potential-free state can also be desired in a transportation means, but also during downtimes. In this case, the combined disconnect/main switch is designed so that it basically acts as a changeover switch. Ideally, the potential is reduced to ground via a resistor after switching over.

The isolator switches preferably have a contact stud which can be moved in a sleeve with at least two contact rings, wherein one contact ring is connected to the negative pole of a storage/converter cell and the other contact ring is connected to the positive pole of another storage/converter cell. In the normal, closed position of the isolator switch, there is therefore an electrical connection between the two contact rings via the contact stud. This means that the two storage cells are series-connected by the isolator switch. After the event sensor has been triggered, this connection is disconnected and the series connection is thus broken.

The isolator switches can be actuated in different ways. For example, a solenoid can be provided on each isolator switch, the solenoid being fed by a conventional 12 V battery. In this case, an energy store is provided which presses the isolator switch into its open position. The isolator switch is therefore only closed when the battery voltage is applied to the solenoid. The event sensor then only has to interrupt the connection to the 12 V battery. All isolator switches then move to the open position. In the case of a transportation means, this configuration has the additional advantage in that the voltage is also divided each time the transportation means is switched to the rest position.

However, if there is an unforeseen event, such as a collision or a fire, situations can arise in which a strong mechanical deformation, exposure to excessive heat or high acceleration prevents the energy store from being triggered. A gas generator is therefore particularly advantageously provided, which can be triggered via the event sensor, wherein the isolator switches are able to be brought from the closed into the open position by the gas pressure generated by the gas generator. The gas pressure generated by such gas generators is usually so high that it also acts accordingly under adverse conditions and safely transports the contact studs into the open position of the isolator switch. Furthermore, the gas has a very positive effect if an arc occurs despite the rapid opening of the isolator switch. In this case, the gas acts as a spark suppressor.

It is possible to use the gas pressure of a gas generator to trigger a plurality of isolator switches. For this purpose, a distribution system could be connected to a gas generator, the distribution system leading to a plurality of isolator switches. However, the sleeves of a plurality of isolator switches are particularly advantageously connected to form a switching tube, wherein the gas generator is provided at one end of the switching tube. In this way, a plurality of isolator switches is series-connected in the direction of flow of the gas, and there is no need for a distribution, which would always be burdened with some deflections and therefore with a drop in pressure.

When connecting the isolator switches in series, it must be ensured that the contact studs do not move to the contact rings of the next isolator switch when the gas generator is triggered, thereby opening one connection but closing another. The switching tube therefore advantageously has notches between the isolator switches. Any reduction in the inner diameter of the switching tube is to be understood as a notch here, regardless of whether it is caused, for example, by a bead or by webs.

The force that acts on each of the contact studs due to the gas pressure should be approximately the same amount. It is therefore particularly advantageous for the contact studs to have continuous gas passage openings that are concentric or parallel to their central longitudinal axis, wherein the cross section of the gas passage openings is smaller for a contact stud having a greater distance from the gas generator than for a contact stud having a smaller distance from the gas generator. This means that the end face of the contact studs, on which the gas pressure acts, increases with increasing distance between the contact studs and the gas generator. With an appropriate design of the gas passage openings, the force that acts on each contact stud remains approximately the same, since the gas pressure decreases with increasing distance from the gas generator, but the surface area on which the gas pressure acts increases.

In a particularly preferred embodiment of the invention in an electrically driven transportation means, a gas generator is provided which is connected to two switching tubes. A large number of contact studs are provided in each switching tube and the switching tubes are each provided with a main switch at the end opposite the gas generator. Each main switch has a contact stud and three contact rings of the switching tube, wherein one of the contact rings is connected to the negative pole or to the positive pole of a series-connected storage/converter cell, the second of the contact rings is connected to the negative pole or the positive pole of the load circuit and the third of the contact rings is connected to the ground of the transportation means. In this embodiment, an optimum is achieved between the safety of users or helpers in the event of an accident of an electrically driven means of transport and the costs incurred by this additional safety device.

Further details and advantages of the invention arise from the description of an embodiment, which is explained in detail with reference to the drawing.

Shown are:

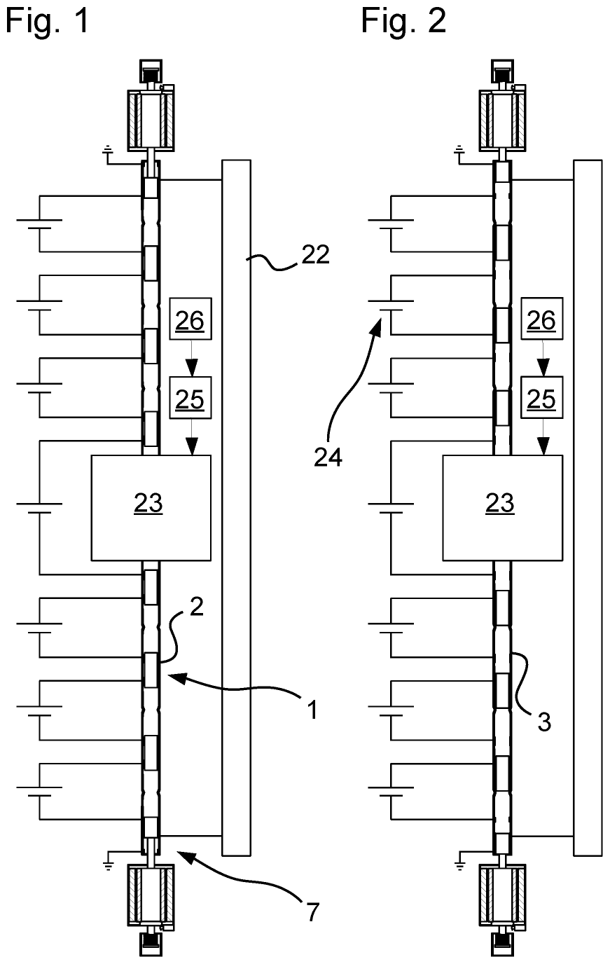

FIG. 1 a schematic representation of a circuit arrangement according to the invention in an electrically operated motor vehicle while driving,

FIG. 2 the circuit arrangement from FIG. 1 after an accident,

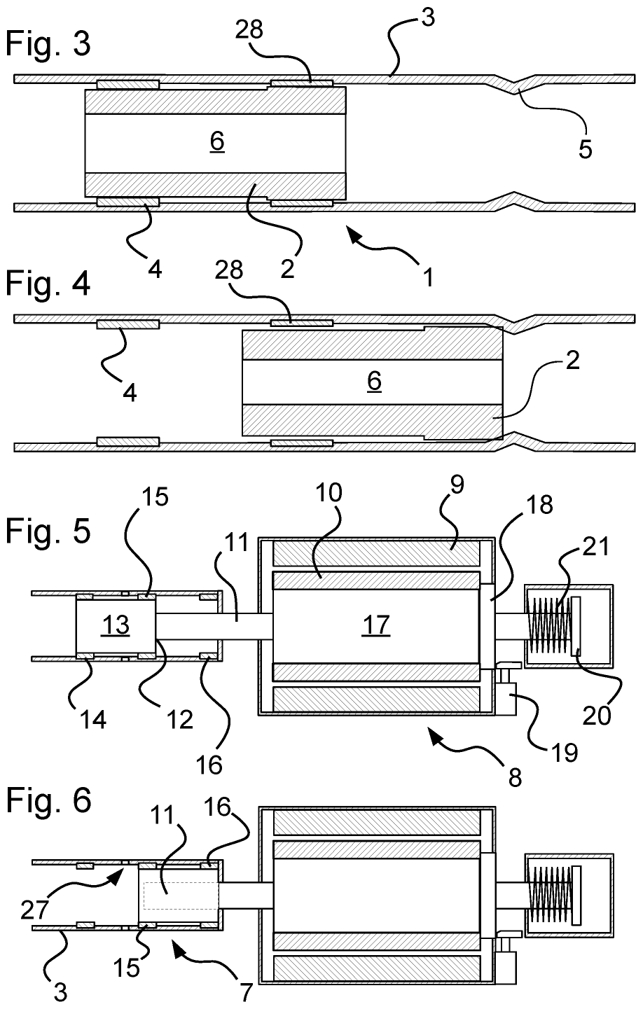

FIG. 3 a schematic sectional view of an isolator switch for connecting series-connected storage cells,

FIG. 4 an isolator switch as in FIG. 3 in its open position after being triggered in an accident,

FIG. 5 a schematic sectional view of a main switch for connecting a load circuit to a network of series-connected storage cells in the closed position and

FIG. 6 the main switch of FIG. 5 after triggering in an accident.

The embodiment of a circuit arrangement shown in FIGS. 1 and 2 for use in a transportation means according to the invention, for example, in an electric vehicle, has a load circuit 22 which can be connected to a battery pack composed of several groups of storage cells 24 via two main switches 7. The groups of storage cells 24 each consist of a plurality of individual series-connected storage cells, wherein the output voltage of each group should remain below 50 V. Assuming that lithium-ion cells having 3.6 V each are used, a group 24 of 13 cells each gives an output voltage of 46.8 V.

In the example shown here, seven such groups 24 are series-connected via isolator switches 1. The structure of the isolator switch 1 and the main switch 7 will be discussed in detail later. The voltage applied to the load circuit is approximately 330 V. When higher voltages are required, either storage cells having a higher output voltage can be used or even more groups 24 are series-connected via further isolator switches 1.

A gas generator 23 is provided which has two outputs, wherein a switching tube 3 is connected to the gas generator 23 at each output. The isolator switches 1 are formed by the switching tube 3 with contact rings 4 (see FIG. 3) and each a gas-powered contact stud 2, the main switch 7 also through the switching tube 3 with contact rings 14, 15, 16 (see FIGS. 5-6) and another designed contact stud 13. In this way, three isolator switches 1 and a main switch 7 are implemented on each side of the gas generator 23 so that all eight switches can be actuated via the gas generator 23.

Furthermore, an impact sensor 26 and a controller 25 are shown in FIGS. 1 and 2. Usually, the controller 25 and the impact sensor 26 do not necessarily have to be implemented as part of the circuit shown. For example, in every vehicle used for passenger transportation today, there are airbags that are also equipped with gas generators. A controller is used to trigger these airbags, the controller receiving a signal from an impact sensor and converting this into an activation signal for the gas generators of the airbags. This signal can also be tapped for the activation of the gas generator 23 in FIGS. 1 and 2. In this case, no specially installed impact sensor and no specially installed controller need be used to activate the gas generator 23.

FIGS. 3 and 4 illustrate an isolator switch 1 in detail in section. Annular depressions are provided for receiving the contact rings 4, 28 in the inner surface of the switching tube 3. The contact rings 4, 28 are connected to the positive pole of a storage cell or to the negative pole of another storage cell in a manner not shown here. The two contact rings 4, 28 are connected to one another in an electrically conductive manner via the contact stud 2 in the closed position of the isolator switch 1 (see FIG. 3).

The contact ring 4 is made somewhat stronger than the contact ring 28. At the same time, the contact stud 2 has a correspondingly enlarged diameter in the region of the contact ring 28. When the contact stud 2 moves to the right in the opening direction, the contact stud 2 only has to overcome the friction to the contact rings 4, 28 for a short distance due to this configuration. After a very short distance, the contact stud 2 can further move practically without frictional resistance.

The switching tube 3 is provided with a bead 5 in the opening direction next to the contact stud 2. This bead 5 has the task of stopping the contact stud 2 when the contact stud is moved from its position shown in FIG. 3 by the gas pressure of a gas generator. This results in a defined end position for the contact stud 2.

In the open position of the isolator switch 1, the contact stud 2 assumes this end position shown in FIG. 4. Here, the contact stud 2 no longer touches both contact rings 4, 28, but is possibly only connected to the right contact ring 28, but not over the entire area. This eliminates the series connection of the two storage cells.

However, the isolator switch shown in FIG. 3 is not the same in FIG. 4. FIG. 4 shows a contact stud to illustrate the different gas passage openings 6, the position of which is further away from the gas generator than the contact stud from FIG. 3.

It can be clearly seen that the gas passage opening of the contact stud in FIG. 3 is larger than that of the contact stud in FIG. 4. As a result, the end face of the contact stud in FIG. 3 that opposes the gas pressure is smaller than that of the contact stud in FIG. 4. Only a part of the gas present at the end face thus passes through the gas passage opening in a contact stud.

This leads to a pressure drop on the opposite side of the contact stud. A lower gas pressure is therefore present at the next contact stud in the row. However, in order to keep the thrust force generated by the gas pressure above a certain amount even with this contact stud, the contact surface on the end face is larger with this contact stud and the cross section of the gas passage opening is therefore smaller.

FIGS. 5 and 6 show an embodiment of a main switch 7 having a linear drive 8 for its actuation. The linear drive 8 is designed here as a stepper motor, by means of which a push rod 11 can be linearly displaced along the axis of rotation of the stepper motor. The stepper motor has a stator 9 fixedly installed in the drive housing and a rotor 10 rotatably mounted within the stator 9. A threaded nut 17 is provided concentrically to the axis of rotation of the rotor 10, the threaded nut being connected torque-proof to the rotor 10, but being mounted displaceably along the axis of rotation of the rotor 10.

A push rod 11 is also provided concentric to the axis of rotation of the rotor 10, the push rod being mounted such that it is displaceable along the axis of rotation, but does not take part in the rotation of the rotor 10 and the threaded nut 17 connected torque-proof thereto. The push rod 11 is provided in the region of the threaded nut 17 with an external thread which is in operative contact with the internal thread of the threaded nut 17.

At its end opposite the main switch 7, the push rod 11 is provided with a push rod flange 20. This protrudes into a spring housing, which is installed in a fixed position to the drive housing. The spring 21 is located between the push rod flange 20 and the internal wall of the spring housing facing the drive housing, the spring pretensioning the push rod flange 20 slightly against the internal wall of the spring housing opposite the drive housing.

The round nut flange 18, which is located in a corresponding recess in the drive housing, is connected to the threaded nut 17. In addition to the recess for the nut flange 18, a solenoid 19 is fastened to the drive housing. This solenoid 19 is provided with a locking lever which, when the solenoid 19 is energized, locks the nut flange 18 and in this way prevents the threaded nut 17 from displacement in the direction of the axis of rotation of the rotor 10.

The main switch 7 is constructed such that the contact stud 13 is installed displaceably within the fixedly mounted switching tube 3. The contact stud 13 is designed as a hollow cylinder which is closed on its end face facing away from the push rod 11. On its open side, it is connected to the push rod 11 via a predetermined breaking point 12.

The predetermined breaking point 12 is not explicitly shown in the drawing, but a possible embodiment will be explained below. The predetermined breaking point 12 is preferably designed as a separate component. It has an inner ring which is connected to the push rod 11. It also has an outer ring which is connected to the open edge of the hollow cylinder of the contact stud 13. The inner and outer edges are connected to one another via three rays arranged in a star shape.

The rays are designed so that they break off when a predetermined force acts between the inner and the outer ring. The rays therefore form the actual predetermined breaking point.

The switching tube 3 has three annular depressions in its internal wall, into which depressions the contact rings 14, 15 and 16 are inserted. The left contact ring 14 is in contact with the storage cells 24, the middle 15 with the load circuit 22 and the right 16 with the ground. The contact stud 13 is designed such that it can electrically connect two contact rings to one another.

The gas outflow openings 27 are provided between the left 14 and the middle contact ring 15, close to the middle contact ring 15, through which gas outflow openings 27 the gas generated by the gas generator 23 can flow out as soon as the contact stud 13 is in the position shown in FIG. 6.

In the following, the function of the invention will now be explained based on an electric vehicle. In the rest position of the electric vehicle, not shown here, the two main switches 7 assume a position in which the contact studs 13 only contact the middle contact ring 15. There is therefore no voltage at the load circuit 22.

The solenoid 19 of each main switch 7 is located in the lowered position so that the nut flange 18 is not blocked. In this position, not shown here, however, no force acts on the push rod 11 due to the spring 21, since the push rod flange 20 rests on the right side wall of the spring housing.

The isolator switches 1 are all in the position shown in FIG. 1. They contact both contact rings 4, 28 at the same time. This means that all groups of storage cells 24 are connected to one another, that is, the full voltage would be available. However, this voltage is not yet present at the load circuit 22.

If the ignition key is now inserted into the ignition lock, the solenoid 19 is energized via the 12 V on-board battery and moves into its blocked position as shown in FIGS. 5 and 6. Now the linear motor 8 is also connected to the vehicle electrical system.

If the ignition key is turned, the linear motor 8 is energized so that the rotor 10 rotates a predetermined number of steps. The push rod 11 is displaced into the operating position shown in FIG. 5. In this position, the contact stud 13 now connects the contact ring 14 to the storage cells 24 with a connection and the contact ring 15 to the load circuit 22 with a connection. The load circuit 22 is supplied with voltage in this operating position. The controllers of the load circuit 22 will not be explained further here.

When the electric vehicle is switched off, the linear motor 8 is energized when the ignition key is turned back such that the rotor 10 rotates in the opening direction. The push rod 11 and the contact stud 13 are pushed back into the rest position, not shown here. The main switch 7 is again in its open position, in which the load circuit 22 is not connected to the storage cells 24 and is therefore not supplied with voltage. When the ignition key is removed, the solenoid 19 falls back into its unblocked position.

Should the 12 V on-board battery fail for any reason during the operation of the electric vehicle, it would no longer be possible to disconnect the storage cells 24 from the load circuit 22, since the linear drive 8 can no longer be energized. The spring 21 and the solenoid 19 are provided for this situation. Starting from the operating position shown in FIG. 5, if the 12 V on-board voltage fails, the solenoid 19 falls back and the locking lever moves into its release position.

Starting from the operating position shown in FIG. 5, the force of the spring 21 now acts on the push rod 11 via the push rod flange 20 and displaces this together with the threaded nut 17 and the contact stud 13 to the right until the push rod flange 20 rests on the right internal wall of the spring housing. The main switch 7 is now in the open position, not shown, as has already been described above. The connection between the storage cells 24 and the load circuit 22 is consequently interrupted.

The electric vehicle can be put back into operation as soon as a repair has been carried out. When the ignition key is inserted into the ignition lock, the locking lever of the solenoid 19 cannot be moved into its blocked position, since the nut flange 18 prevents it from doing so. The controller, not shown here, therefore energizes the linear drive 8 in the opening direction. Since the push rod 11 cannot be displaced further to the right, the threaded nut 17 is pressed back into the rotor 10 to the left. After reaching the normal position of the threaded nut 17, as illustrated in FIGS. 5 and 6, the locking lever of the solenoid 19 can now move back into its blocked position and the electric vehicle is ready to start again. The main switch 7 can be brought back into its operating position shown in FIG. 5 by energizing the linear motor 8 in the closing direction.

If the electric vehicle is involved in an accident, the load circuit 22 will be disconnected from the storage cells 24 very quickly. At the same time, however, the groups of storage cells will also be disconnected from one another so that only voltages that are harmless to people can occur.

Starting again from the operating position of the two main switches 7 shown in FIG. 5, the gas generator 23 is ignited in the middle between the two switching tubes 3 via an impact sensor 26 and a controller 25 (see FIG. 1). The resulting gas presses the contact studs 2 of the isolator switch 1 provided on both sides of the gas generator 23 into the open position shown in FIG. 4. Since only one of the contact rings is now contacted by each contact stud 2, there is no longer any connection between the individual groups of storage cells 24. In the case described here, only voltages of approximately 46.8 V can consequently be transmitted to electrically conductive parts of the electric vehicle. There is thus no longer any danger for people.

Since the contact studs 2 of the isolator switch 1 have all gas passage openings 6, there is still enough pressure in front of the contact studs 13 of the two main switches 7 to take effect here. As a result, the predetermined breaking point 12 breaks and the contact stud 13 is pressed to the right until it rests on the side wall of the switch housing facing the linear drive 8. This position of the main switch 7 is shown in FIG. 6. So that the internal pressure does not lead to an explosion of the switching tube 3, gas outflow openings 27 are provided between the left contact ring 14 and the middle contact ring 15, the gas outflow openings being only really clear when the contact stud is located completely in the position shown.

In FIG. 6, the contact stud 13 establishes a connection between the contact ring 15 to the load circuit 22 with connection and the contact ring 16 to ground with connection. In this way, not only can the load circuit be disconnected from the storage cells in the event of an accident, but it can also be discharged. In the embodiment shown in FIGS. 1 and 2, two main switches 7 are provided, wherein the contact ring 15 of the one main switch is connected to the positive connection of the load circuit 22 and the contact ring 15 of the other main switch is connected to the negative connection of the load circuit 22. In this case, both the negative connection and the positive connection of the load circuit are connected to ground in the event of an accident.

### REFERENCE LIST

1 isolator switch
2 gas pressure driven contact studs
3 switching tube
4 first contact ring
5 stop beads
6 gas passage opening
7 main switch
8 linear drive
9 rotor
10 stator
11 push rod
12 predetermined breaking point
13 contact stud of the main switch
14 contact ring with connection to the storage cells
15 contact ring with connection to the load circuit
16 contact ring with connection to ground
17 threaded nut
18 round nut flange
19 solenoid with locking lever
20 push rod flange
21 spring
22 load circuits
23 gas generator
24 storage cells or groups of storage cells
25 controller
26 impact sensor
27 gas outflow opening
28 second contact ring

1. An electrical system, having a load circuit (22) and a plurality of series-connected storage/converter cells (24) for supplying the load circuit (22), and having an event sensor (26), characterized in that closed isolator switches (1) are provided between series-connected storage/converter cells (24) during normal operation of the electrical system, said isolator switches (1) being designed and/or arranged such that they are opened when the event sensor (26) is triggered.

2. The electrical system according to claim 1, characterized in that the isolator switches (1) are located between groups of storage/converter cells (24) which are combined such that each group delivers a voltage which is not harmful to people.

3. The electrical system according to one of claims 1 to 2, characterized in that at least one additional isolator switch (1) is provided between the series-connected storage/converter cells (24) and the load circuit (22), the isolator switch being in a closed position in normal operation of the electrical system.

4. The electrical system according to claim 3, characterized in that the at least one additional isolator switch is combined with a main switch (7) which, after triggering the event sensor (26), is in a position in which the load circuit (22) is short-circuited to the ground (16) of an electrically driven transportation means.

5. The electrical system according to any one of claims 1 to 4, characterized in that the isolator switches (1) have a contact stud (2) which is movable in a sleeve (3) with at least two contact rings (4, 28), wherein one contact ring is connected to the negative pole of a storage/converter cell (24) and the other contact ring is connected to the positive pole of another storage/converter cell (24).

6. The electrical system according to any one of claims 1 to 5, characterized in that a gas generator (23) is provided which can be triggered via the event sensor (26), wherein the isolator switch (1) is able to be brought from the closed to the open position by the gas pressure generated by the gas generator (23).

7. The electrical system according to claim 6, characterized in that the sleeves of a plurality of isolator switches (1) are connected to form a switching tube (3), wherein the gas generator (23) is provided at one end of the switching tube (3).

8. The electrical system according to claim 7, characterized in that the switching tube (3) has notches between the isolator switches (1).

9. The electrical system according to one of claims 7 to 8, characterized in that the contact studs (2) have continuous gas passage openings (6) that are concentric or parallel to their central longitudinal axis, wherein the cross section of the gas passage openings (6) is smaller for a contact stud having a greater distance from the gas generator (23) than for a contact stud having a smaller distance from the gas generator (23).

10. The electrical system according to any one of claims 7 to 9 in an electrically driven transportation means, characterized by the following features:
two switching tubes (3) are connected to a gas generator (23)
a large number of contact studs (2) are provided in each switching tube (3)
the switching tubes (3) are each provided with a main switch (7) at the end opposite the gas generator (23)
each main switch (7) has a contact stud (13) and three contact rings (14; 15; 16) of the switching tube (3), wherein one of the contact rings (14) is connected to the negative pole or to the positive pole of a series-connected storage/converter cell, the second of the contact rings (15) is connected to the negative pole or the positive pole of the load circuit and the third of the contact rings (16) is connected to the ground of the transportation means.
